(19) United States
(12) Patent Application Publication
(10) Pub. No.: US 2008/0243041 A1
(43) Pub. Date: Oct. 2, 2008

(54) Butt and thigh massager

(76) Inventors: Patricia Brenner, Encino, CA (US); Greg Snyder, San Rafael, CA (US)

Correspondence Address: LOZA & LOZA LLP, 305 N. Second Avenue, #127, Upland, CA, 91786-6064, US

(21) Appl. No.: 12/053,535

(22) Filed: Mar. 21, 2008

Related U.S. Application Data
(60) Provisional application No. 60/908,305, filed on Mar. 27, 2007.

(51) Int. Cl. A61H 7/00

(52) U.S. Cl. 601/151; 601/134

(57) ABSTRACT

One aspect provides a wearable garment having built-in massage components at multiple positions to massage areas of the thighs and/or lower butt. The garment may be adjustable to fit users of different sizes. This wearable massager provides a deep massage in areas that are difficult and/or tedious to get to when using other do-it-yourself massagers. This wearable massager employs a rotating longitudinal friction action (in contrast to a vibrating action) thereby eliminating the need to push on the massager. The wearable massager may allow a wearer to relax while receiving a massage.

### CLAIM OF PRIORITY UNDER 35 U.S.C. §119

The present Application for Patent claims priority to Provisional Application No. 60/908305 entitled “Butt and Thigh Massager” filed Mar. 27, 2007 and is hereby expressly incorporated by reference herein.

### FIELD

The invention relates to the field of massaging devices, in particular, to a wearable garment that includes massaging elements that are secured to the user.

### BACKGROUND

One type of prior art massaging device includes handheld massagers that a user holds and moves to a desired location for massaging. Such handheld devices typically massage a very small region at any one time and require that the user exert some force to provide an adequate massage. Because the user must be holding and pressing the massager, the user is not able to fully relax and enjoy said massage.

Another type of prior art massaging device includes mat or cushion massagers that a user sits on to massage his/her back. These massagers require a user to move to adjust him/her-self to the massager. Thus, they fail to conform to a user's body. Also, such massagers typically only massage a back surface of the user and thus fail to massage side or front muscles.

Another type of prior art massaging device is a wearable massager, but it only creates a vibration effect and/or a heating effect. It does not provide the rubbing massage that is similar to a massage given by another person.

Consequently, a massager is needed that conforms to different user body sizes and body locations. And it massages several muscles at once providing a rubbing massage effect without requiring a user to apply manual force.

### SUMMARY

One example provides a wearable massager comprising: (a) a plurality of straps adaptable to retain massaging components against the waist and upper leg portions of a wearer; (b) a plurality of longitudinal massaging components coupled to the garment to massage the wearer's butt and thigh muscles; (c) an electric motor coupled to the massaging components to cause the massaging components to turn, thereby massaging the wearer's butt and thigh muscles in longitudinal direction; and/or (d) one or more heating elements to provide heat to muscles being massaged. The one or more heating elements may rotate along with the longitudinal massaging components. The plurality of massaging components may be capable of massaging along multiple different surfaces at once. The plurality of massaging components may be driven by a mechanism that rotates massaging elements along a longitudinal direction as the massaging elements massage the wearer.

In one example, the massaging components may include a plurality of massaging elements that are pivotally joined to conform to a wearer's shape. In another example, the massaging components may include one or more massaging elements that provide a rubbing, non-vibrating motion against a muscle being massaged.

The massaging components may include one or more massaging elements that provide a unidirectional longitudinal rubbing motion. The number of massaging components coupled to the straps may be increased or decreased to accommodate a desired massage.

The wearable massager may also include an adjustable garment coupled to the plurality of straps, wherein the massaging components are detachably coupled to the garment so that a wearer can reposition the massaging components in the garment to massage a desired muscle area. The garment may include a first and second leg portions that are detachable so that they can be independently positioned to massage a desired muscle area. The straps may open to unfold the garment and close to wrap the garment around the wearer.

A leg massaging device, comprising: (a) a driving motor; (b) one or more massaging components adapted to be rotated by the driving motor in a longitudinal direction, wherein the one or more massaging components massage by a longitudinal frictional rubbing action against a muscle; (c) one or more heating elements to provide heat to muscles being massaged; (d) means for adjustably coupling the device to a leg; and/or (e) a garment configured in the shape of shorts adapted to hold the one or more massaging components. In one example, the massaging components may include one or more massaging elements that provide a longitudinal rubbing, non-vibrating motion against a muscle being massaged. In another example, the massaging components may include one or more massaging elements that provide a unidirectional rubbing motion.

### BRIEF DESCRIPTION OF THE FIGURES

FIG. 1 illustrates a front view of a garment having built in massage components according to one example.

FIG. 2 illustrates a front view of a garment partially unwrapped with massage components according to one example.

FIG. 3 illustrates a view of a massage element being secured to a leg using a garment in a strap configuration

FIG. 4 illustrates one implementation of the wearable massager with multiple massaging elements coupled to each other that can be adjusted to conform to the user.

FIG. 5 illustrates one implementation of the wearable massager with a continuous band massaging element using straps to secure the massaging element to the user.

FIG. 6 illustrates some of the internal components of a continuous band massaging element, including infrared LED's for heating.

FIG. 7 illustrates some of the internal components of a continuous band massaging element including the electric motor, gears and rollers.

FIG. 8 illustrates one implementation of the wearable massager with a plurality of exposed roller massaging elements, using straps to secure the massaging element to the user.

FIG. 9 illustrates some of the internal components of an exposed roller massaging element including the electric motor and gears.

FIG. 10 illustrates a hand held controller and an external power supply connected to a massaging element.

### DETAILED DESCRIPTION OF THE INVENTION

In the following detailed description of the invention, numerous specific details are set forth in order to provide a thorough understanding of the invention. However, the invention may be practiced without these specific details. In other instances well known methods, procedures, and/or components have not been described in detail so as not to unnecessarily obscure aspects of the invention.

One aspect of the present invention provides a garment having built-in massage components at multiple positions to massage areas of the thighs, lower butt, and/or leg muscles. The garment may be adjustable to fit users of different sizes. This wearable massager provides a deep massage in areas that are difficult and/or tedious to get to when using other do-it-yourself massagers. Conventional handheld massagers require constant pressure to be applied to obtain the expected results. By contrast, the present wearable massager eliminates the need to push on the massager. The wearable massager allows a wearer to relax while receiving a massage.

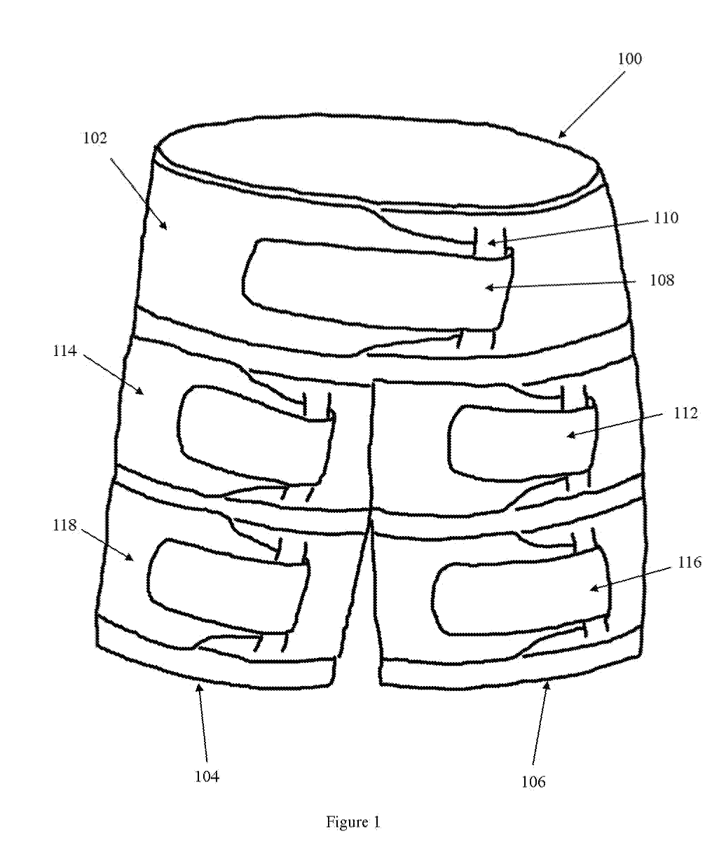

FIG. 1 illustrates a front view of garment 100 having built-in massage components according to one example. The garment 100 may resemble biking shorts and may form an upper portion 102 and two leg portions 104 and 106.

The garment 100 may include a plurality of adjustable straps to tighten the garment around the body of the wearer. The upper portion 102 includes a first strap 108 that passes through a loop 110 and folds to allow a wearer to tighten the strap. Similarly, each leg portion 104 and 106 may include one or more straps that tighten around a wearer's leg. For instance, the first leg portion 104 may include a second strap 114 and third strap 118 while the second leg portion 106 may include a fourth strap 112 and a fifth strap 116. In various implementations, the straps may be tightened using Velcro™, buckles, and/or other means.

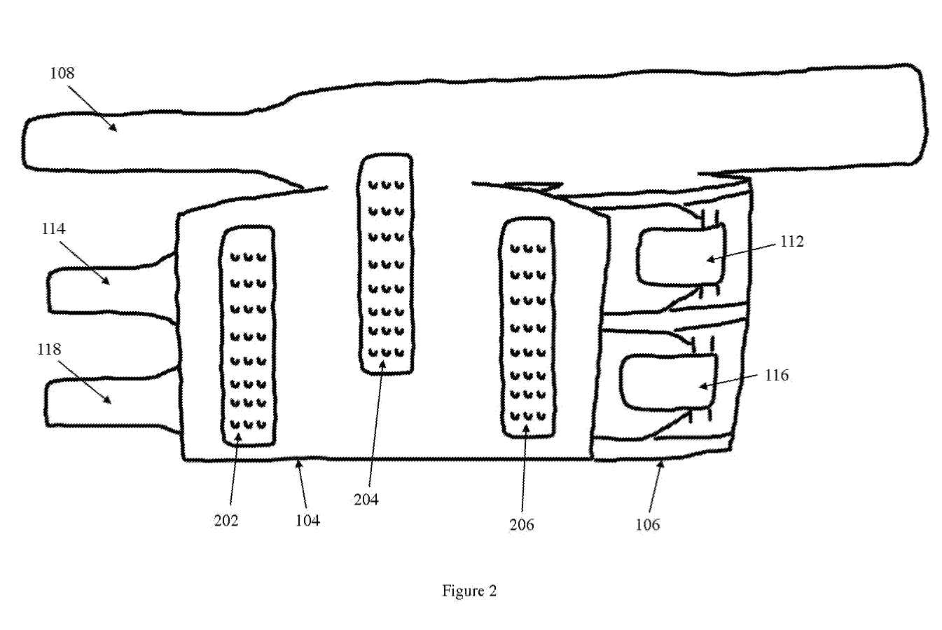

FIG. 2 illustrates a view of the garment 100 partially unwrapped. The first strap 108 at the upper portion 102 is shown unwrapped. Likewise, the second and third straps 114 and 118 at the first leg portion 104 are unwrapped. The fourth and fifth straps 112 and 116 at the second leg portion 106 are shown wrapped.

A plurality of active massaging elements 202, 204 and 206 are shown coupled to the first leg portion 104 of the garment 100. The massaging elements 202, 204 and 206 may be coupled to either an inside or outside surface of the garment or sandwiched between layers of the garment. The massaging elements 202, 204 and 206 may be coupled to an internal or external power source that cause the massaging elements 202, 204 and 206 to move, vibrate, and/or rotate to stimulate or massage the thigh or butt muscles of the wearer. Note that the straps 108, 112, 114, 116, and 118 may be tightened to press the massaging elements 202, 204 and 206 against the wearer's butt and/or thigh muscles. Similarly, the second leg portion 106 includes one or more massaging elements. Thus, the wearer may adjust the strength of the massage by tightening or loosening the straps.

In other implementations, the garment may not unwrap as illustrated in FIG. 2 but rather slip on or off the wearer like regular shorts with the straps providing a means to tighten them around the wearer.

The location and/or position of the massaging elements 202, 204, and/or 206 may be adjusted by the wearer to conform to a wearer's body and/or desired muscles massage. For example, the massaging elements may be moved or positioned within the garment at different locations (using Velcro™ or other attachments) to massage a particular muscle or area desired by a wearer. Thus, the massaging elements may massage the back, sides and/or front of the wearer's thigh and/or butt muscles. Additionally, because the massaging elements are secured to the user, the user may get a massage while walking, jogging, standing, sitting, or laying down.

In another implementation, the first and second leg portions 104 and 106 may be removable or detachable from each other so that each leg portion 104 and 106 can be rotated and/or positioned as desired on each leg. This allows a wearer to independently position each leg portion independent of the location of the other leg portion. In such implementation, the leg portions 104 and 106 may be removable from the upper portion 102.

The use of the garment 100 as a support structure for the massaging elements 202, 204, and 206 allows the straps to be tightened around the leg/thigh muscles without having them slip down. The use of garment 100 with tightening straps also allows a wearer to get a massage without pressing on a solid backing or support surface as is often required by other prior art massagers. That is, the wearer may tighten the straps to press the massaging elements against his/her body, thus avoiding the need for a supporting surface.

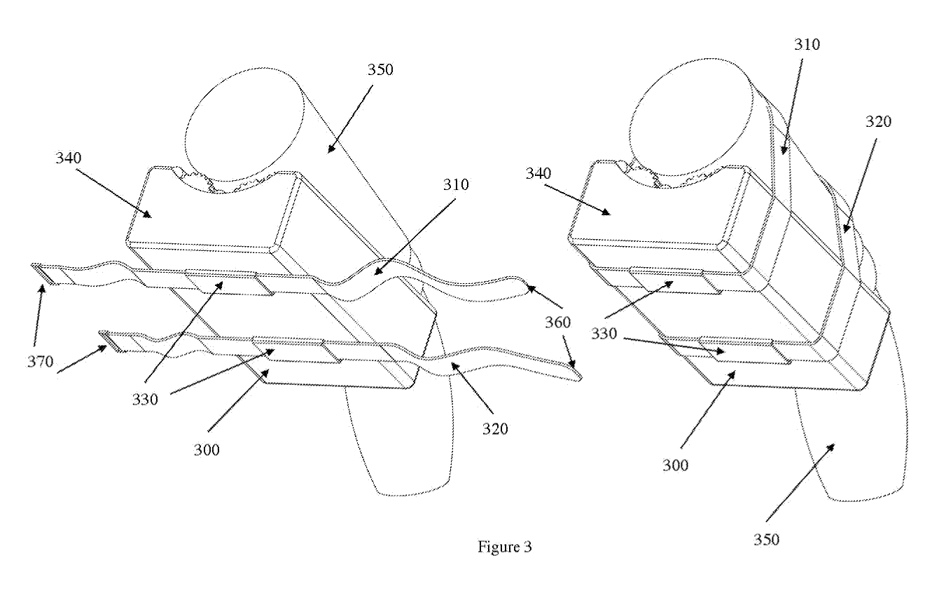

FIG. 3 shows an embodiment where the massaging element 300 is secured to the user using a garment in a strap configuration. The straps 310 and 320 are secured to the massaging element in slots 330 on the back of the housing 340 and the user simply tightens the straps 310 and 320 around the legs 350 or butt depending on what region they prefer to apply pressure from the massaging elements. The straps in this configuration are secured around the user by feeding the strap end 360 through the buckle 370 and pulling to tighten. In various implementations, the straps may be tightened using Velcro™, buckles, and/or other means. The straps 310 and 320 may also be secured to the massaging element 300 with Velcro™, snaps or other methods. In this implementation, the user could wear the massaging element 300 under another garment for warmth, privacy or other reasons. The user can also position the massaging element 300 at any location on the legs or butt. Also, multiple massage elements may be used at the same time, for example one on each leg.

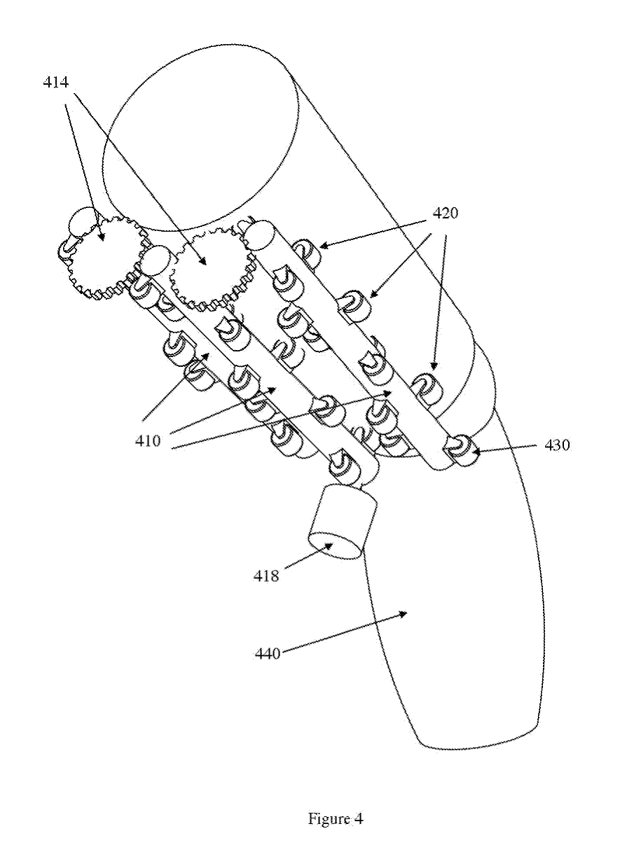

FIG. 4 illustrates shows the massaging element 300 from FIG. 3 of the wearable massager with the housing and garment hidden. In this example, the massaging element 300 may include multiple massaging components 410 that are coupled to each other by gears 414. A motor 418 is coupled at one end of the massaging component 410 to cause the multiple massaging components to rotate, vibrate, or move, thereby massaging the wearer's butt and/or thigh muscles. In various examples, the massaging element 300 may, for example include two or three massaging components 410 coupled via gears 414. By using gears, the massaging components 410 may rotate relative to each other and conform to the wearer's body automatically to provide a more localized massage.

In another implementation of a massaging element 300 the massaging components 410 may be coupled to each other using timing belts and pulleys or some other method. Alternatively, each massaging component 410 may be coupled to an individual motor 418 so that each massaging component 410 may be rotated, vibrated or moved independently to create a variety of massaging experiences.

In one example, a massaging component 410 may be a longitudinal rod having a plurality of nodes or knuckles 420 that serve to massage a wearer's butt and/or thigh muscles as the massaging component 410 rotates. The nodes or knuckles 420 may be offset at different degrees along the longitudinal rod to provide a constant rubbing massaging sensation to the wearer. The nodes or knuckles 420 may include rollers 430 at the tips that rotate or roll when they come in contact with the user's muscles. The nodes or knuckles may be made of a rigid, flexible or compressible material. Alternatively, the nodes or knuckles may themselves be rollers.

The massaging components 410 may be adjusted relative to each other to better conform to a wearer's muscles and/or leg 440. That is, the position, location, and/or angle of the individual massaging components 410 may be adjusted. Because the massaging element 300 is wearable and are secured to the user, they mold themselves to the wearer's body shape, thereby providing a customized fit to wearers of different body shapes.

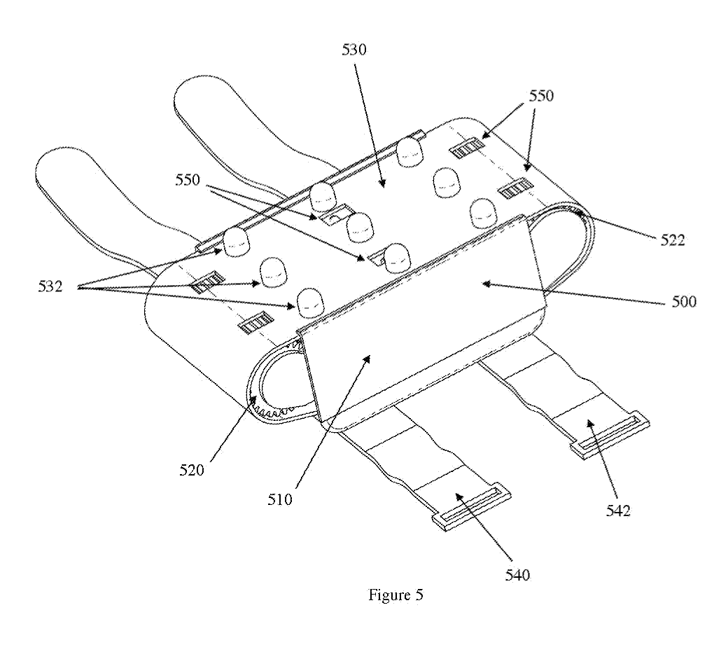

FIG. 5 illustrates another type of massaging element 500 that may be employed to massage a wearer's butt and/or thigh muscles. This massaging element 500 includes a housing 510 that holds a plurality of rollers 520 and 522. A continuous band 530 wraps around the rollers 520 and 522 and rotates when the rollers turn. The band 530 may include a plurality of bumps 532 that provide a rubbing massaging sensation to the wearer. In various configurations, the bumps 532 may be placed in a linear or non-linear fashion on the band 530 to provide different massaging sensations. This massaging element 500 includes several infrared LED's for generating heat to enhance the massaging experience. The band 530 contains openings that allow the heat to pass through when the openings pass over the infrared LED's. The massaging element 500 may be secured to the wearer using the straps 540 and 542 just like the massage element 300 in FIG. 3. The user can also position the massaging element 500 at any location on the legs or butt. Also, multiple massage elements may be used at the same time, for example one on each leg.

One advantage of this massaging element 500 is that it may be configured to rotate in a single direction to provide a unidirectional longitudinal rubbing massaging motion. In one example, such unidirectional longitudinal rubbing massaging motion may simulate a lymphatic massage to help improve blood flow in the legs to treat edema. In contrast to prior art massaging elements that operate in a single point of contact, a longitudinal massaging element provides continuous contact (massaging) along a larger region.

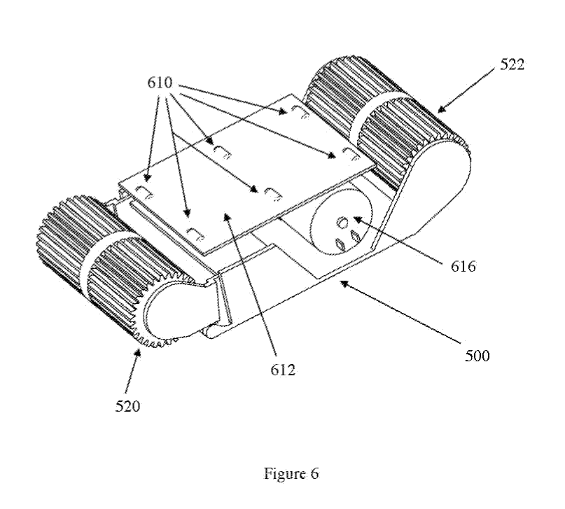

FIG. 6 illustrates the massaging element 500 from FIG. 5 with the internal components exposed. Infrared LED's 610 are mounted to a printed circuit board 612 for transmitting heat to the user thru the windows 550 in the band 530 as seen in FIG. 5. The infrared heat may be transmitted through the nodes 532 as well if the nodes are made of a material that transmits infrared energy efficiently. In addition, infrared LED's may be placed on the side of the band 530 so the heat may be transmitted directly to the user instead of through the windows 550 in the band 530. Other methods of generating heat could be used such as ultrasonic energy or resistive heating elements. The driver motor 616 can be partially seen in this figure.

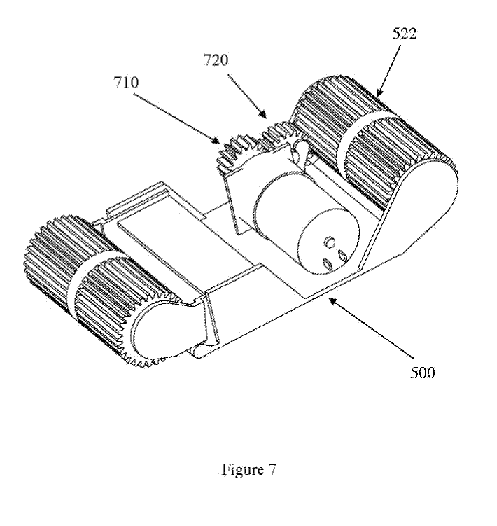

In FIG. 7 illustrates the massaging element 500 from FIG. 5 with more internal components exposed. An electric motor 616 is connected to gears 710 and 720 which are attached to roller 522 that drives the band 530 in FIG. 5.

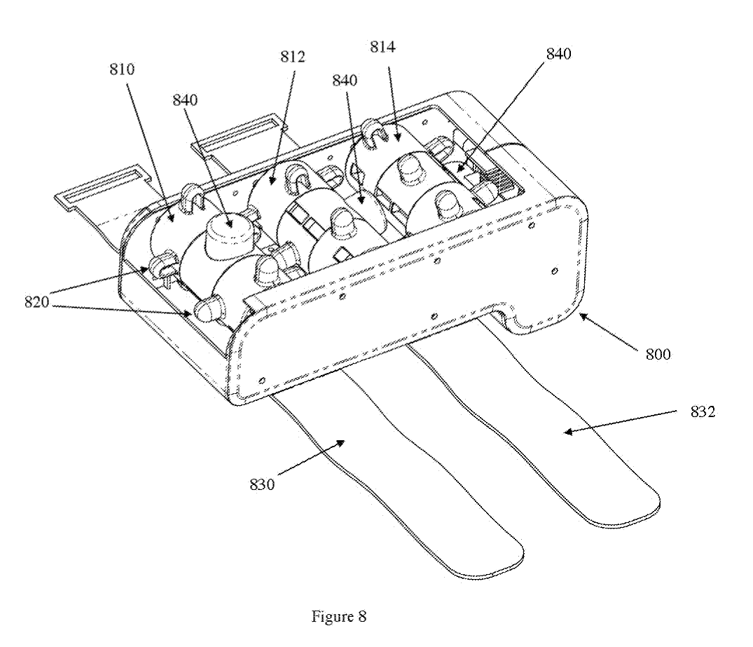

FIG. 8 illustrates yet another type of massaging element 800 where a plurality of exposed rollers 810, 812 and 814 running transversely to the length of the massaging element 800 contain a plurality of bumps 820 that provide a rubbing massaging sensation to the wearer. The rollers 810, 812 and 814 may be configured to roll all in the same direction to create a continuous longitudinal rubbing massaging sensation to the user. In other configurations, the rollers may rotate in opposite directions to each other to create a squeezing and pinching sensation where the rollers 810, 812 and 814 are rolling toward each other. The massaging element 800 is secured to the wearer using the straps 830 and 832 just like the massage element 300 in FIG. 3. The user can also position the massaging element 800 at any location on the legs or butt. Also, multiple massage elements may be used at the same time, for example one on each leg.

The massaging rollers 810, 812 and 814 may include ultrasonic transducers 840 at various spacings around each roller 810, 812 and 814. These ultrasonic transducers 840 generate ultrasonic energy at the correct power and frequency to generate heat on the user's legs or butt. The ultrasonic transducers 840 are turned on alternatively one at a time only when the transducer is in the position where it is pressing against (or comes into contact with) the user's skin. This allows only a single ultrasonic frequency generator to be used in the massaging element 800. Alternatively, multiple ultrasonic frequency generators may be used.

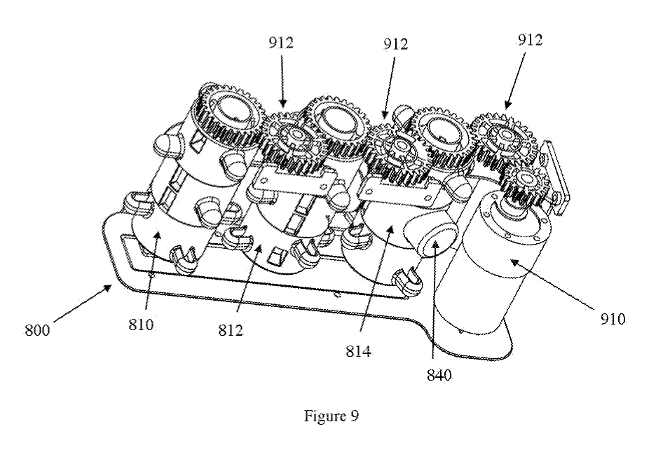

FIG. 9 illustrates the massaging element 800 with the internal components exposed. There is an electric motor 910 directly connected to a gear 912 that is connected to the roller 814. Each roller is connected to another gear 912 that drives the next roller. This allows a single electric motor 910 to drive all of the rollers 810, 812 and 814 in the same rotational direction. In another configuration, the rollers could be connected directly to each other so they rotate in opposite directions from each other.

Rather than using vibrating elements (in which a weight merely oscillates back and forth), one example of the massaging elements may be rubbing (non-vibrating) elements that massage by frictional action against a muscle. In some embodiments, the massaging element may be configured with or without heating elements. In some embodiments the massaging nodes may be constructed of a frictional gel material that generates its own heat from rubbing against the user's skin.

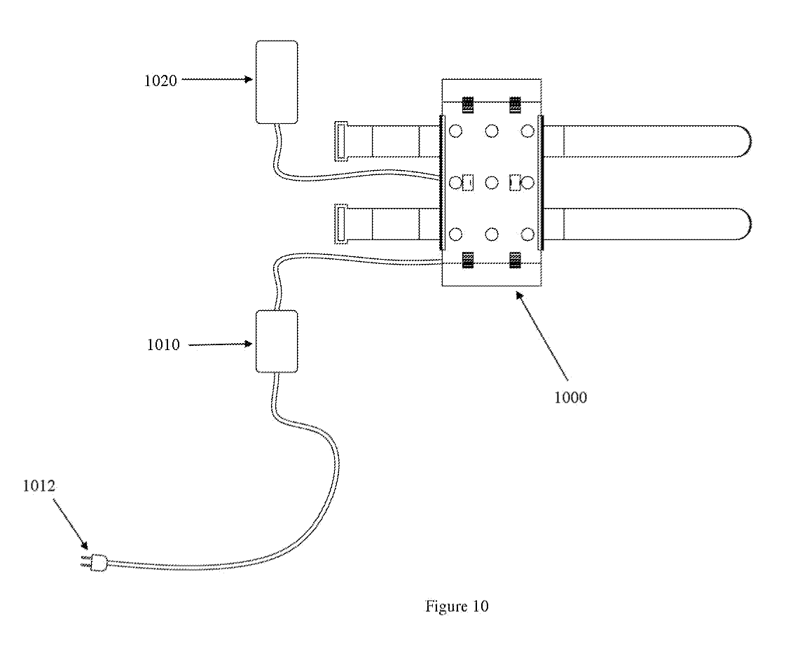

In one embodiment, the massaging element may be powered externally by plugging it into a wall outlet. FIG. 10 illustrates a wearable massaging element 1000 connected to an external power supply 1010 that has a wall plug 1012 that can be plugged into a wall. The advantage of this embodiment is that it will run for long periods of time without concern about power dissipation. This also allows the design to use more powerful electric motors without a concern about power dissipation. Alternate embodiments may power the massaging element with batteries either internally or externally.

In a preferred embodiment, the massaging element functions are controlled by a handheld controller. FIG. 10 illustrates a wearable massager element 1000 that has a handheld controller 1020 that is connected to the massager element 1000 The handheld controller 1020 can control the operation of the massager element 1000 including turning the power on and off, turning the motion of massaging element on and off, turning the heating function on and off, increasing or decreasing the heat output for the heating function, changing the speed of the massaging element, changing the direction of motion of the massaging element, setting the massaging time, and setting different massaging programs that will automatically change the settings as the massaging time elapses. The handheld controller may also control other functions that can be included into the massager operation.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A wearable massager comprising:
a plurality of straps adaptable to retain massaging components against the waist and upper leg portions of a wearer; and
a plurality of longitudinal massaging components coupled to the garment to massage the wearer's butt and thigh muscles.

2. The wearable massager of claim 1 further comprising:
an electric motor coupled to the massaging components to cause the massaging components to turn, thereby massaging the wearer's butt and thigh muscles in longitudinal direction.

3. The wearable massager of claim 1 wherein the massaging components include a plurality of massaging elements that are pivotally joined to conform to a wearer's shape.

4. The wearable massager of claim 1 wherein the massaging components include one or more massaging elements that provide a rubbing, non-vibrating motion against a muscle being massaged.

5. The wearable massager of claim 1 wherein the massaging components include one or more massaging elements that provide a unidirectional longitudinal rubbing motion.

6. The wearable massager of claim 1, further comprising a
an adjustable garment coupled to the plurality of straps, wherein the massaging components are detachably coupled to the garment so that a wearer can reposition the massaging components in the garment to massage a desired muscle area.

7. The wearable massager of claim 6 wherein the garment includes a first and second leg portions that are detachable so that they can be independently positioned to massage a desired muscle area.

8. The wearable massager of claim 6 wherein the straps open to unfold the garment and close to wrap the garment around the wearer.

9. The wearable massager of claim 1 wherein the number of massaging components coupled to the straps can be increased or decreased to accommodate a desired massage.

10. The wearable massager of claim 1 further comprising:
one or more heating elements to provide heat to muscles being massaged.

11. The wearable massager of claim 10 wherein the one or more heating elements rotate along with the longitudinal massaging components.

12. The wearable massager of claim 1 wherein the plurality of massaging components are capable of massaging along multiple different surfaces at once.

13. The wearable massager of claim 1 wherein the plurality of massaging components are driven by a mechanism that rotates massaging elements along a longitudinal direction as the massaging elements massage the wearer.

14. A leg massaging device, comprising:
a driving motor; and
one or more massaging components adapted to be rotated by the driving motor in a longitudinal direction, wherein the one or more massaging components massage by a longitudinal frictional rubbing action against a muscle.

15. The device of claim 14, further comprising:
one or more heating elements to provide heat to muscles being massaged.

16. The device of claim 14, further comprising:
means for adjustably coupling the device to a leg.

17. The device of claim 14, further comprising:
a garment configured in the shape of shorts adapted to hold the one or more massaging components.

18. The device of claim 14 wherein the massaging components include one or more massaging elements that provide a longitudinal rubbing, non-vibrating motion against a muscle being massaged.

19. The device of claim 14 wherein the massaging components include one or more massaging elements that provide a unidirectional rubbing motion.
